(19) United States
(12) Patent Application Publication
(10) Pub. No.: US 2024/0416365 A1
(43) Pub. Date: Dec. 19, 2024

(54) MULTI-FUNCTIONAL NOZZLE ASSEMBLY

(71) Applicant: A. RAYMOND ET CIE, Grenoble (FR)

(72) Inventor: Larry M. RACHOW, Lenox, MI (US)

(21) Appl. No.: 18/698,545

(22) PCT Filed: Oct. 4, 2022
(86) PCT No.: PCT/IB2022/059457

§ 371 Date: Apr. 4, 2024

Related U.S. Application Data
(60) Provisional application No. 63/252,307, filed on Oct. 5, 2021.

(51) Int. Cl. B05B 1/14; B05B 1/08; B60S 1/52; B60S 1/56

(52) U.S. Cl. CPC B05B 1/14; B05B 1/08; B60S 1/52; B60S 1/56

(57) ABSTRACT

A nozzle assembly for cleaning a vehicle surface is provided. The nozzle assembly includes a nozzle head including a manifold comprising an internal cleaning media passage having a plurality of cleaning media passageways, a cleaning media inlet, and a plurality of nozzles carried by the nozzle head, each of the plurality of nozzles fed by one of the plurality of cleaning media passageways and having at least one outlet through which cleaning media is sprayed. At least one of the nozzles; provides a different flow rate, flow type, pressure, direction, or spray pattern of cleaning media, collectively creating a multi-functional spray of cleaning media.

### CROSS-REFERENCE TO RELATED APPLICATION(S)

The present application claims the benefit of U.S. Provisional Application No. 63/252,307, filed Oct. 5, 2021, which is incorporated herein by reference in its entirety.

### FIELD OF THE INVENTION

The present disclosure relates to a nozzle assembly for cleaning vehicle surface, for example a sensor, a camera, or a window.

### DESCRIPTION OF THE RELATED ART

Various cleaning devices for vehicles are known, including nozzles that clean windows, headlights, and other vehicle surfaces. Exterior cameras and driver assistance sensors are increasing in popularity, and many vehicle models have these as standard or optional equipment. Due to the impact of environmental elements to these cameras and sensors, these systems can experience a loss in effectiveness. Said nozzles can be used to clean the lenses of these systems. Self-driving or autonomous vehicles require an even greater number of cameras and sensors for navigation and guidance, driving and safety, and internal performance.

Unfortunately, however, conventional nozzles and related cleaning devices suffer from numerous drawbacks, including a requisite increase in manufacturing costs and labor, system weight, and number of individualized components needed (e.g. for new models/designs) associated with the solutions outlined above. Many conventional nozzle designs are tailored for a specific vehicle surface, limiting the usefulness of the nozzle on different vehicle surfaces. In newer vehicle designs requiring a greater number of cameras and sensors, such as for self-driving or autonomous vehicles, space and weight constraints make conventional nozzles undesirable and impractical.

### SUMMARY OF THE INVENTION

A fluid nozzle assembly for cleaning a vehicle surface is provided. In one embodiment, the fluid nozzle assembly includes a nozzle head including a manifold comprising an internal cleaning media passage having a plurality of cleaning media passageways, a cleaning media inlet, and a plurality of nozzles carried by the nozzle head, each of the plurality of nozzles fed by one of the plurality of cleaning media passageways and having at least one outlet through which cleaning media is sprayed. At least one of the nozzles provides a different flow rate, flow type, pressure, direction, or spray pattern of cleaning media, the nozzle assembly thereby collectively providing a multi-functional spray of cleaning media.

In these and other embodiments, the fluid nozzle assembly may be adapted to clean a vehicle window, a camera sensor, a LIDAR sensor, and a CMHSL, and the plurality of nozzles includes a window nozzle comprising at least one outlet orifice that is oriented to direct fluid toward the window, a camera sensor nozzle comprising at least one outlet orifice that is oriented to direct fluid toward the camera sensor, a LIDAR sensor nozzle comprising at least one outlet orifice that is oriented to direct fluid toward the LIDAR sensor, and a CMHSL nozzle comprising at least one outlet orifice that is oriented to direct fluid toward the CMHSL.

These and other features and advantages of the present invention will become apparent from the accompanying description of the invention, when viewed in accordance with the accompanying drawings and appended claims.

### BRIEF DESCRIPTION OF THE DRAWINGS

In the drawings:

FIG. 1 is a perspective view of a nozzle assembly in accordance with a first aspect of the disclosure, the nozzle assembly having a plurality of nozzles and a manifold;

FIG. 2 is an exploded view of the nozzle assembly;

FIG. 3 is a partially exploded view of the nozzle assembly, showing internal features forming the manifold;

FIG. 4 is a bottom view of the nozzle assembly, showing a first nozzle;

FIG. 5 is partial front view of the nozzle assembly, showing a spray of cleaning media from the first nozzle;

FIG. 6 is a perspective view of the nozzle assembly showing a second nozzle comprising a oscillating fan chip, the chip exploded from a nozzle receiver;

FIG. 7 is a rear view of the second nozzle, with the first nozzle body removed for clarity, showing a spray of cleaning media from the second nozzle;

FIG. 8 is a partially exploded view of the nozzle assembly, showing an alternate embodiment of the second nozzle comprising an in-mold oscillating fan nozzle integrally formed with the nozzle head;

FIG. 9 is a perspective view of the nozzle assembly showing a third nozzle comprising a static fan spray tip, the tip exploded from a nozzle receiver;

FIG. 10 is partial front view of the nozzle assembly, showing a spray of cleaning media from multiple nozzles;

FIG. 11 is a perspective view of the nozzle assembly showing a fourth nozzle comprising an eye ball-type nozzle tip, the tip exploded from a nozzle receiver; and

FIG. 12 is a schematic view of the nozzle assembly installed on a vehicle in proximity to a vehicle window, a camera sensor, a LIDAR sensor, and a CMHSL.

### DETAILED DESCRIPTION

A fluid nozzle assembly for cleaning a vehicle surface, such as a sensor, a camera, or a window, or other surface is described below. As will be appreciated from the description here, the nozzle assembly has multiple applications, but is generally used as a device for delivering cleaning media to a vehicle surface or multiple vehicle surfaces, such as a sensor, a camera, a window, or any combination thereof. It is to be understood that the nozzle assembly may be used to deliver cleaning media to clean other surfaces, such as a headlight or headlamp, other vehicle surfaces, or other surfaces in non-automotive applications. The nozzle assembly is adapted to vary any one or more of the flow rate, flow type (e.g. laminar or turbulent flow), pressure, direction, or spray pattern of cleaning media delivered through one or more nozzles or nozzle outlets. The nozzle assembly can have a plurality of nozzles or nozzle outlets arranged to apply cleaning media to multiple surfaces and/or on multiple planes.

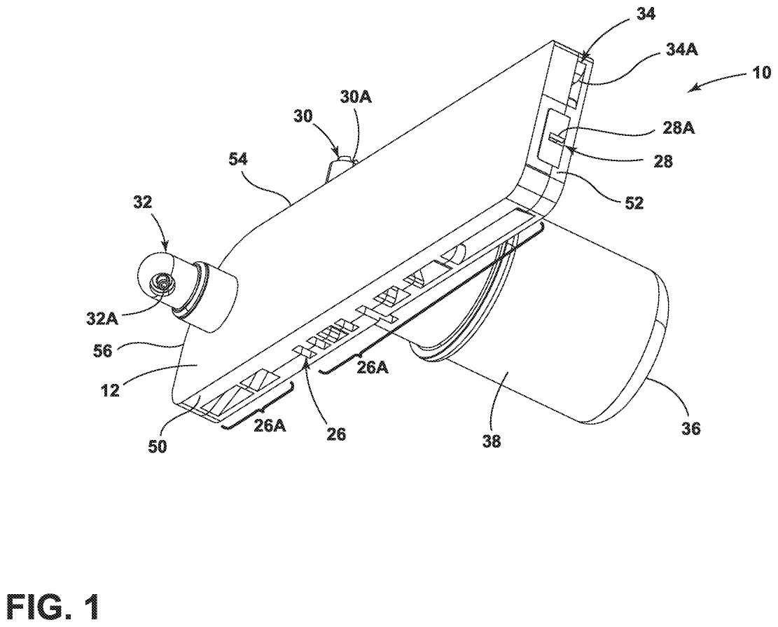

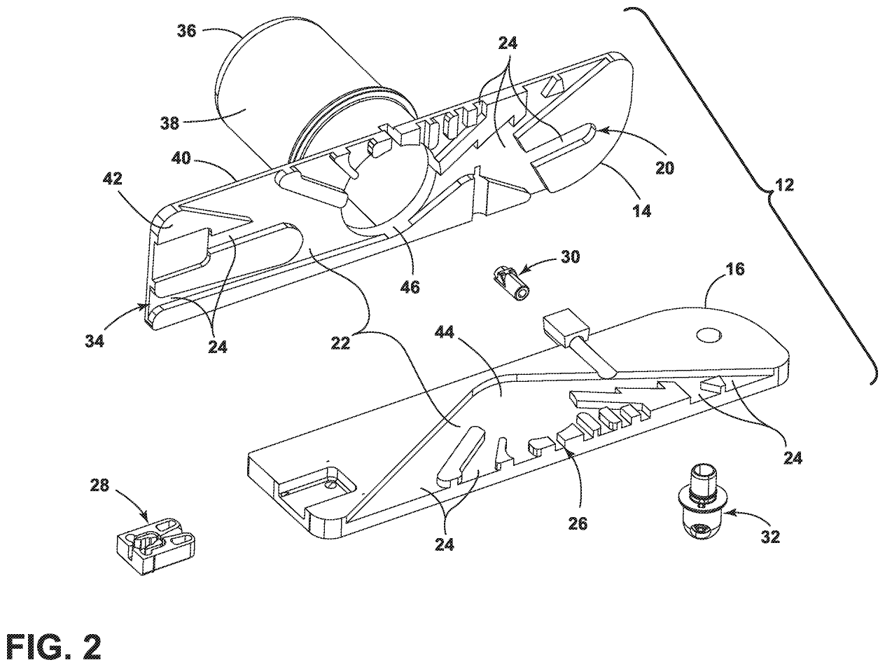

In FIGS. 1-2, a nozzle assembly for cleaning a vehicle surface according to a first aspect of the disclosure is illustrated and generally designated 10. The nozzle assembly 10 includes a nozzle head 12 including a first nozzle body 14 and a second nozzle body 16. The second nozzle body 16 can comprise a nozzle cap attached to the first nozzle body 14. A manifold is defined by the first nozzle body 14 and the second nozzle body or nozzle cap 16, the manifold comprising an internal cleaning media passage 22 having a plurality of cleaning media passageways 24. A plurality of nozzles 26, 28, 30, 32, 34 are carried by the nozzle head 12, and the nozzles 26, 28, 30, 32, 34 are fed by one of the cleaning media passageways 24. Each nozzle 26, 28, 30, 32, 34 includes at least one outlet 26A, 28A, 30A, 32A, 34A through which cleaning media is sprayed. The nozzle head 12 may be mounted in proximity to multiple vehicle surfaces, with the plurality of nozzles 26, 28, 30, 32, 34 or the outlets 26A, 28A, 30A, 32A, 34A of the nozzles arranged to apply cleaning media to the multiple surfaces, which may comprise different vehicle surfaces or surfaces oriented on different planes.

A cleaning media inlet 36 is fluidly coupled to the nozzle head 12 and a cleaning media is supplied to the nozzle head 12 from a cleaning media source (not shown) through the inlet 36. In general, the cleaning media inlet 36 is adapted for flow of cleaning media into the manifold from outside of the nozzle head 12. The cleaning media inlet 36 may be of any size and/or shape, and may be integral with, fixed to, and/or otherwise connected and/or fastened to the first nozzle body 14 or another portion of the nozzle head 12.

It is appreciated that the nozzle assembly 10 may be part of a system including a cleaning media source and any number of conduits, ducts, tubing, hoses, fluid connectors, valves, and/or controllers, utilized to fluidly couple the various components of the system together and/or other provide a controllable flow path from the cleaning media source to the nozzle assembly 10. Likewise, it is to be appreciated that the cleaning media is typically put under pressure via an external system, e.g. a pump or compressor (not shown), and the cleaning media flowing through the manifold will be under pressure as it passes through the internal passage and out of the nozzles 26, 28, 30, 32, 34. In certain embodiments, the system comprises a heating element (not shown) for heating the cleaning media before it is applied to a vehicle surface.

The outlets 26A, 28A, 30A, 32A, 34A of the nozzles 26, 28, 30, 32, 34 can be any type of cleaning media outlets, suitable for the purposes described herein, including the spraying or dispensing of cleaning media to a vehicle surface. The outlets 26A, 28A, 30A, 32A, 34A can be configured to produce various spray patterns, e.g. a fan spray, a jet spray, etc. For example, in certain embodiments, a spray-building element (e.g. an insert, limiter, director, rotator, etc. can be provided at one of the outlets to achieving or otherwise configure/produce particular spray patterns (e.g. focused/directed jet sprays, oscillating sprays, combinations of jet and fan sprays, etc.). The outlets 26A, 28A, 30A, 32A, 34A can be arranged to apply cleaning media to multiple surfaces, which may comprise different vehicle surfaces or surfaces oriented on different planes.

The nozzles 26, 28, 30, 32, 34 can be any type of cleaning media nozzles, suitable for the purposes described herein, including the spraying or dispensing of cleaning media to a vehicle surface through one or more outlets. Some non-limiting examples of nozzles include: an in-mold static fan nozzle to produce a static fan spray pattern; a static fan nozzle tip to produce a static fan spray pattern; an adjustable eye ball-type nozzle tip to produce a conical spray pattern; an oscillating fan chip to produce an oscillating fan spray pattern; and an in-mold oscillating fan nozzle to produce an oscillating fan spray pattern. The nozzles 26, 28, 30, 32, 34 can be arranged to apply cleaning media to multiple surfaces, which may comprise different vehicle surfaces or surfaces oriented on different planes. In generally, an “in-mold” nozzle is integrally formed with the nozzle head 12 whereas a “tip” is formed separately from the nozzle head 12 and mounted, attached, coupled, or otherwise joined to the nozzle head 12.

The nozzles 26, 28, 30, 32, 34 may be integrally formed with the nozzle head 12, or separately formed and attached to the nozzle head 12. Examples of nozzles that may be attached to the nozzle head 12 include a chip or a nozzle tip. With integral or separate, one or more of the nozzles can comprise a spray building element, such as a chip or eyeball, for achieving spray patterns, such as a jet spray, an oscillating fan spray or a combination jet and fan spray.

In the embodiment of the nozzle assembly 10 shown, the nozzle assembly 10 includes five nozzles carried by the nozzle head 12 and supplied with cleaning media from a common inlet 36 via the manifold and its internal passage 22. It is understood that with regard to the nozzle assembly 10, the number and type of nozzles is not particularly limited, and may be implemented in various configurations. In general, multiple varied nozzles are preferred in order to apply cleaning media to multiple surfaces and/or on multiple planes. The embodiment of the nozzle assembly 10 shown in FIG. 1-2 may be particularly suited to cleaning a vehicle window, a camera sensor, a LIDAR sensor, and a CMHSL.

In the embodiment shown, the cleaning media inlet 36 is formed on the first nozzle body 14. The cleaning media inlet 36 can be a supply conduit 38 extending from a first side 40 of the nozzle body 14, where the nozzle cap 16 is attached to a second side 42 of the nozzle body 14 opposite the first side 40. The first side 40 of the nozzle body 14, which may be an exterior side, can face away from a side of the first nozzle body 14 which defines the manifold. An inner surface 44 of the nozzle cap 16 may be disposed in opposition to an outlet 46 of the supply conduit 38, the outlet 46 of the supply conduit 38 supplying cleaning media to the internal cleaning media passage 22.

In general, the first and second nozzle bodies 14, 16 are attached or joined in a fluid-tight manner such that the manifold and internal cleaning media passageway 22 is enclosed, save for the cleaning media inlet 36 and plurality of outlets 26A, 28A, 30A, 32A, 34A. The nozzle bodies 14, 16 may be attached or joined via any technique or combination of techniques known in the art. For example, in certain embodiments, the first nozzle body 14 and the second nozzle body 16 are each separately integrally formed (e.g. via injection molding, additive manufacturing, etc.) and then are subsequently attached together. In certain embodiments, attaching the nozzle bodies 14, 16 comprises snap-fitting them together. Of course, various other methods and/or combinations of methods of attachment may also be utilized.

The nozzle head 12 can include a perimeter edge including at least one peripheral surface 50, 52, 54, 56. The perimeter edge of the nozzle head 12 may be formed by mating surfaces of the first and second nozzle bodies 14, 16, or one of the nozzle bodies 14, 16. The peripheral surface 50, 52, 54, 56 may be a surface that is exposed to a vehicle surface, such that a nozzle disposed at the peripheral surface 50, 52, 54, 56 can spray cleaning media onto the vehicle surface. In the embodiment illustrated, the nozzle head 12 has multiple peripheral surfaces 50, 52, 54, 56 and has nozzles on more than one of the peripheral surfaces 50, 52, 54, 56.

The nozzle head 12 can carry a variety of different nozzles on different areas of the nozzle head 12. Each nozzle may have a particular flow requirements in order to deliver cleaning media from its outlet in a predetermined flow rate, flow type, pressure, direction, or pattern type. Accordingly, the passageways 24 may have different (e.g. unequal) fluid volumes, lengths, widths, depths, and/or other passageway characteristics, in order to properly distribute cleaning media to each nozzle and ensure the flow requirements of each nozzle is met. It is noted that the fluid volume of a cleaning media passageway which feeds a nozzle can be defined by the amount of space, measured in cubic units, that a cleaning media can occupy between an inlet to the passageway and an inlet to the nozzle which is fed by the passageway. The length of a cleaning media passageway can be defined by the distance between the inlet to the passageway and the inlet to the nozzle which is fed by the passageway.

The nozzle head 12 can have internal features forming the manifold 20, including the internal cleaning media passage 22 and passageways 24. The internal features can be varied among the different passageways 24 to impact and/or change the outlet characteristics of each outlet 26A, 28A, 30A, 32A, 34A, including one or more of the flow rate, flow type, pressure, direction, or pattern type of cleaning media delivered by the outlet. The internal features can, for example, include channels, diverters, baffles, vanes, and the like, which direct cleaning fluid through the passageways 24 and impart outlet characteristics that result in the cleaning fluid sprayed from each outlet 26A, 28A, 30A, 32A, 34A to have a particular flow rate, flow type, pressure, direction, and/or spray pattern. It is to be understood that that the structure of the nozzle itself can also imparts outlet characteristics that impacts flow rate, flow type, pressure, direction, and/or spray pattern.

In certain embodiments, the manifold 20, including the internal cleaning media passage 22 and passageways 24, is integrally formed with one or both of the nozzle bodies 14, 16 during manufacturing of these components (e.g. via injection molding, additive manufacturing, etc.). Producing the manifold 20 with the nozzle bodies 14, 16 as injection-molded or additive-manufactured parts increases geometric freedom compared to other manufacturing methods. In this way, almost any geometry can be realized with the manifold 20 in the region of each nozzle or nozzle outlet, and accordingly the flow rate, flow type, pressure, direction, and/or spray pattern of cleaning media delivered through each nozzles or nozzle outlet can be varied to effectively clean different vehicle surfaces from a single nozzle head 12.

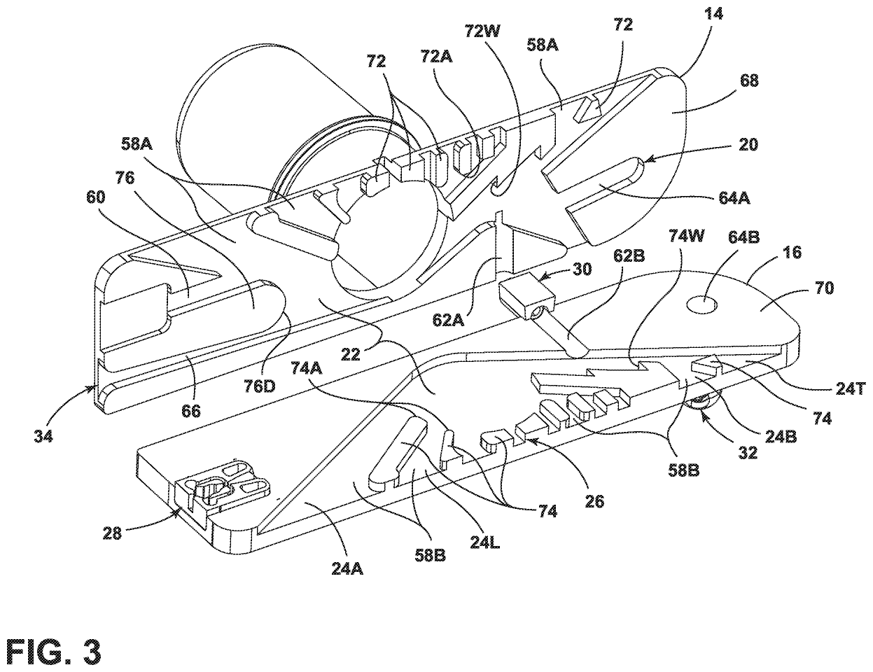

Referring to FIG. 3, the passageways 24 can include channels integrally formed with one or both of the first nozzle bodies 14, 16. The channels can be recessed areas in the internal surface of either nozzle body. For channels formed in one nozzle body and not the other, the channel can be closed by the other nozzle body. For example, the cleaning media passageway supplying the first nozzle 26 includes first channels 58A integrally formed with the first nozzle body 14 and second channels 58B integrally formed with the second nozzle body 16, the second channels 58B mated or coupled with the first channels 58A by the attachment of the nozzle cap 16 to the first nozzle body 14. The cleaning media passageway supplying the second nozzle 28 comprises a channel 60 integrally formed with the first nozzle body 14 and closed by the second nozzle body 16. The cleaning media passageway supplying the third nozzle 30 comprises first and second channels 62A, 62B integrally formed with the first and second nozzle bodies 14, 16, respectively, the channels 62A, 62B being mated or coupled together via the attachment of the nozzle bodies 14, 16. The cleaning media passageway supplying the fourth nozzle 32 comprises a first channel 64A integrally formed with the first nozzle body 14 that mates or couples with a second channel 64B in the second nozzle body 16, where the second channel 64B can extend through the second nozzle body 16 generally orthogonally to the first channel 64A. The cleaning media passageway supplying the fifth nozzle 34 comprises a channel 66 integrally formed with the first nozzle body 14 and closed by the second nozzle body 16.

The depth of the channels and the width of the channels, including the width of an inlet to the channels 58, and the width at the outlet of the channels, can be optimized to meet specific flow rates and/or pressures for each nozzle.

The channels are formed as recessed areas in internal surfaces 68, 70 the nozzle bodies 14, 16. The internal surfaces 68, 70 may be substantially planar or flat in areas where channels or nozzle receivers are not formed. Such internal surfaces 68, 70 may mate together in a fluid-tight manner such that fluid leakage outside the channels is substantially minimized or eliminated.

In certain embodiments, the manifold 20 comprises a plurality of flow diverters dividing the internal cleaning media passage 22 into the passageways 24. The flow diverters may be integrally formed with the first nozzle body 14, the second nozzle body 16, or both the first and second nozzle bodies 14, 16.

Referring to FIG. 3, the plurality of flow diverters can include a first set of flow diverters 72 integrally formed with the first nozzle body 14 and a second set of flow diverters 74 integrally formed the second nozzle body 16. The first set of flow diverters 72 are connected with the second set of flow diverters 74 by the attachment of the first and second nozzle bodies 14, 16, by which connection the sets of flow diverters 72, 74 may mate together in a fluid-tight manner such that fluid leakage past the mated flow diverters is substantially minimized or eliminated.

In other configurations, flow diverters may differ, or may be provided in one nozzle body 14, 16 and not the other. For example, a flow diverter 76 dividing the channels 60, 66 supplying the second nozzle 28 from the fifth nozzle 34 may be formed in the first nozzle body 14.

One or more of the flow diverters 72, 74, 76 can include a divider surface 72D, 74D, 76D, respectively, separating an entrance to a first cleaning media passageway or channel from an entrance to a second cleaning media passageway or channel. Cleaning media flowing through the internal passage 22 encounters the divider surface 72D, 74D, 76D and separates into flows on either side of the divider surface 72D, 74D, 76D to continue into separate passageways or channels. The divider surface 72D, 74D, 76D may be configured to direct more cleaning media into one passageway than the other. The divider surface 72D, 74D, 76D may be configured to impart a laminar or turbulent flow to the cleaning media.

One or more of the flow diverters 72, 74 can include a deflector wall 72W. 74W, extending into an associated passageway or channel and positioned in opposing relationship to a flow direction of cleaning media through the passageway or channel to deflect cleaning media from its flow direction. The deflector wall 72W, 74W may be configured to impart a turbulent flow to the cleaning media traveling through the passageway or channel.

One or more passageways of the internal passage 22 can be configured as a low pressure, high flow passageway 24A. The embodiment shown herein employs one or more structural features for providing low pressure and high flow. For example, the width and/or depth of the passageway 24A can be larger.

One or more passageways of the internal passage 22 can be configured as a high pressure, low flow passageway 24B. The embodiment shown herein employs one or more structural features for providing high pressure and low flow. For example, the width and/or depth of the passageway 24B can be smaller.

In certain embodiments, the nozzle assembly 10 can have a combination of high pressure, low flow and low pressure, high flow passageways 24A, 24B. Some vehicle surfaces may be cleaned better with high pressure, and others with low pressure. Likewise, some vehicle surfaces may be cleaned better with high flow, and others with low flow. In the embodiment shown, for example, the first nozzle 26 comprises at least one low pressure, high flow passageway 24A and at least one high pressure, low flow passageway 24B.

One or more passageways of the internal passage 22 can be configured as a turbulent flow passageway 24T. The embodiment shown herein employs one or more structural features for providing turbulent flow. For example, the flow dividers 72, 74 forming the turbulent flow passageway 24T can be configured with sharp transitions to encourage turbulent flow in the passageway 24T. One or more deflector walls 72W, 74W can projecting into the turbulent flow passageway 24T normal to or oblique to the flow direction.

One or more passageways of the internal passage 22 can be configured as a laminar flow passageway 24L. The embodiment shown herein employs one or more structural features for providing laminar flow. For example, the flow dividers 72, 74 forming the laminar flow passageways 24L can be configured with smooth transitions (e.g., to lack any sharp transitions) to reduce or eliminate any areas of turbulent flow in the passageway 24L.

In certain embodiments, the nozzle assembly 10 can have a combination of laminar and turbulent flow passageways 24L, 24T. Some vehicle surfaces may be cleaned better with laminar flow, and others with turbulent flow. For example, a laminar flow of cleaning media may be optimal for a window, and a turbulent flow of cleaning media may be optimal for a camera or sensor. In the embodiment shown, for example, the first nozzle 26 comprises at least one laminar flow passageway 24L and at least one turbulent flow passageway 24T.

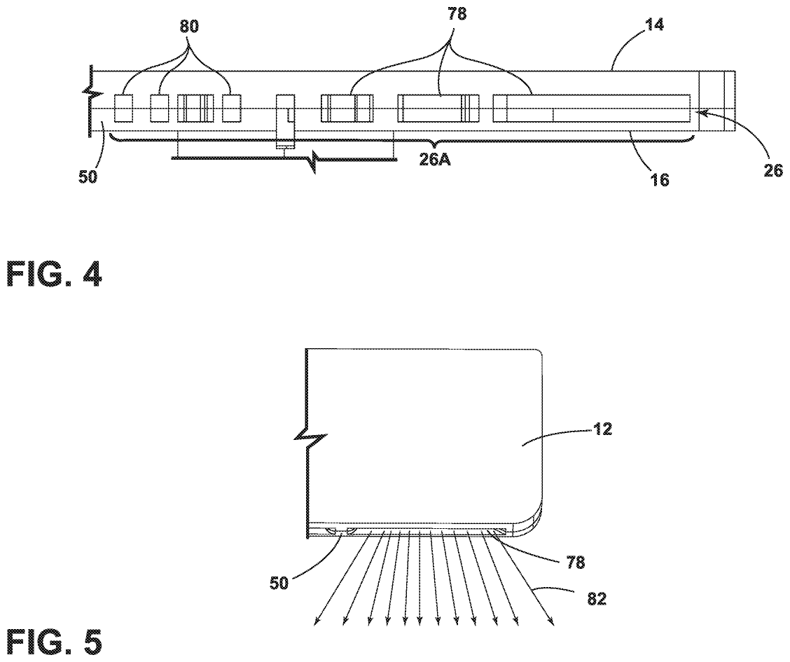

As noted above, the nozzles can be any type of cleaning media nozzles, suitable for the purposes described herein. Referring to FIG. 4-5, the first nozzle 26 is integrally formed with the nozzle head 12 and defined by the first nozzle body 14 and the nozzle cap 16. The first nozzle 26 can be disposed at the first peripheral surface 50 of the nozzle head 12, with the outlet 26A of the first nozzle 26 formed by a plurality of openings 78, 80 through the first peripheral surface 50, the plurality of openings 78, 80 defined by the first nozzle body 14 and the second nozzle body 16. For example, each of the first nozzle body 14 and the nozzle cap 16 can have apertures which align with each other when the nozzle cap 16 is attached to the first nozzle body 14, with each set of aligned apertures forming one outlet opening 78, 80 of the first nozzle 26. The openings 78, 80 may be arranged in a longitudinal array and are oriented to direct a spray pattern 82 outward from the first peripheral surface 50.

The outlet openings 78, 80 can have varied shapes, widths, orientations, at the like to vary one or more of the flow rate, flow type, pressure, direction, or pattern type of cleaning media delivered therethrough. For example, the outlet openings 78, 80 can have varying widths, including one outlet opening 78 having a width that the greater than the width of another outlet opening 80. A wider exit point for cleaning media provides a spray of cleaning media at a lower pressure and higher flow rate, which may be desired for cleaning particular vehicle surfaces. Other vehicle surfaces may be cleaned more efficiently by the narrower outlet openings, which provide a spray of cleaning media at higher pressure and lower flow rate.

As another example, the spray pattern provided by one outlet opening 78 can be different than another outlet opening 80. In one embodiment, at least one outlet opening is a horizontal nozzle opening or orifice 78 for providing a horizontal spray pattern and at least one outlet opening is a vertical nozzle opening or orifice 80 for providing a vertical spray pattern that is transverse to the horizontal spray pattern. The horizontal nozzle orifice 78 has a width that is greater than its height, and the vertical nozzle orifice 80 has a height that is greater than its width. The horizontal nozzle orifices 78 can have unequal widths.

As yet another example, the direction of cleaning media sprayed by one outlet opening can be different than another outlet opening. In FIG. 5, a spray 82 of cleaning media from the outlet openings 78, 80 is indicated by arrows. The spray 82 can fan out generally in a direction outward from the first peripheral surface 50 of the nozzle head 12.

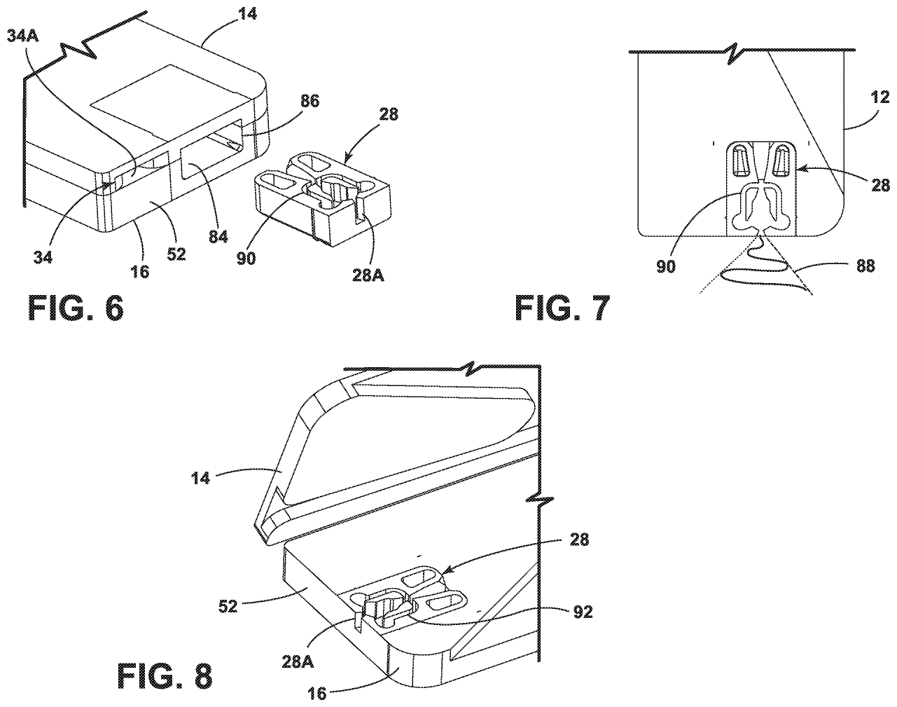

Referring to FIG. 6-7, the second nozzle 28 comprises a chip inserted into a nozzle receiver 84 defined between the first nozzle body 14 and the nozzle cap 16. The second nozzle receiver 84 has a receiver opening 86 at the second peripheral surface 52. The chip 28 can, for example, produce an oscillating fan spray pattern 88, with the chip 28 inserted in the nozzle receiver 84 with its outlet 28A disposed generally at the second peripheral surface 52.

Referring to FIG. 6, in the embodiment shown, the chip 28 comprises a spray-building element 90 defining one of the plurality of outlets 28A for the nozzle assembly 10. The spray-building element 90 is configured to generate an oscillating fan jet or pattern 88. One configuration for the chip 28 is described in U.S. Pat. No. 8,186,608, issued May 29, 2012, the complete disclosure of which is incorporated herein by reference. The oscillating fan spray nozzle 28 may also take on forms different from what is disclosed in the aforementioned reference.

The second nozzle 28 can have a different flow rate, flow type, pressure, direction, and/or pattern type than the first nozzle 26. For example, the direction of cleaning media sprayed by the outlet 28A and the spray pattern 88 can be different. As shown in FIG. 7, the second nozzle 28 produces an oscillating fan spray pattern 88 generally in a direction outward from the second peripheral surface 52 of the nozzle head 12.

Referring to FIG. 8, in another embodiment the second nozzle 28 can be an in-mold oscillating fan nozzle to produce the oscillating fan spray pattern. The second nozzle 28 can comprise in-mold element 92 integrally formed with the second nozzle body or cap 16. Other in-mold spray building elements are possible.

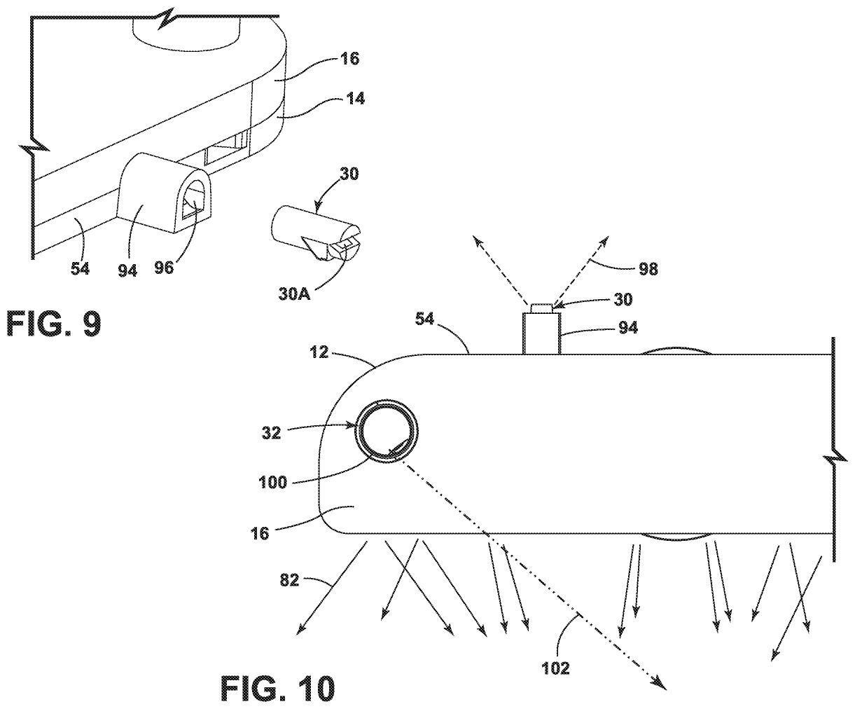

Referring to FIG. 9-10, the third nozzle 30 is formed as a nozzle tip attached to the second nozzle body 16 and inserted into a nozzle receiver 94 formed on the perimeter edge of the nozzle head 12. The third nozzle receiver 94 can, for example, be disposed on the third peripheral surface 54, and can project from the exterior surface, with a receiver opening 96 disposed outward of the third peripheral surface 54. The third nozzle 30 can, for example comprise a static fan nozzle tip to produce a static fan spray pattern 98.

The static fan nozzle tip 30 can be snap-fit to the nozzle receiver 94. The nozzle tip 30 and nozzle receiver 94 can have snap-fit parts which are pushed together to interlock the static fan nozzle tip 30 to the nozzle head 12. Providing the snap-fit parts as integral attachment features on the nozzle tip 30 and nozzle head 12 provides rapid assembly, without the need for tools, and avoids loose parts as found with assembly methods using separate screws or fasteners. Where the nozzle tip 30 and nozzle head 12 are plastic, the snap-fit parts can be integrally formed therewith. Other attachment structures are possible. When installed, the nozzle tip 30 can project outwardly from the third peripheral surface 54.

The third nozzle 30 can have a different flow rate, flow type, pressure, direction, and/or pattern type than the first and/or second nozzle 26, 28. For example, the direction of cleaning media sprayed by the outlet 30A and the spray pattern can be different. As shown in FIG. 10, the third nozzle 30 produces an static fan spray pattern 98 generally in a direction outward from the third peripheral surface 54 of the nozzle head 12.

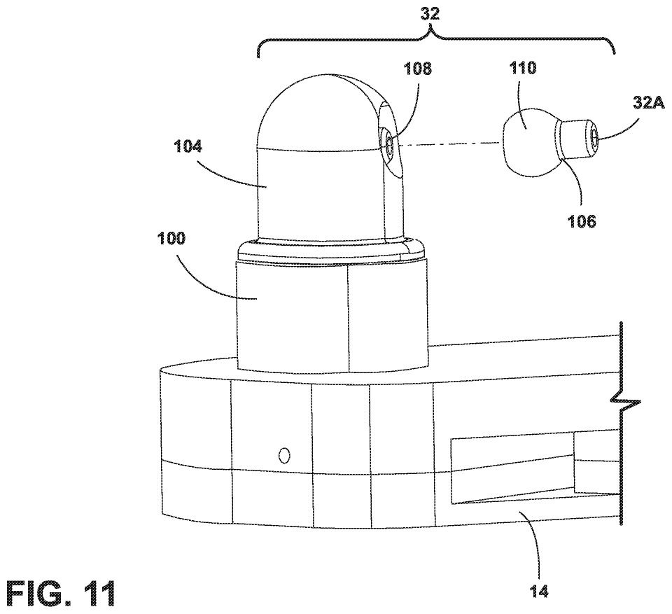

Referring to FIGS. 10-11, the fourth nozzle 32 is formed as a nozzle tip attached to the second nozzle body 16 and inserted into a nozzle receiver 100 formed on the nozzle cap 16. The fourth nozzle receiver 100 can be disposed on the exterior surface of the cap 16, generally opposite the first nozzle body 14 and the cleaning media inlet 36 (FIG. 1). The fourth nozzle 32 can, for example comprise an eye ball-type nozzle tip to produce a jet spray pattern 102.

Referring to FIG. 11, in the embodiment shown, the fourth nozzle 32 can include a nozzle housing 104 and a spray-building element, such as a jet insert 106 (sometimes referred to as an eyeball), inserted into the nozzle housing 104 and defining one of the plurality of outlets 32A for the nozzle assembly 10. The nozzle housing 104 can have an accommodation space 108, and the jet insert 106 can include a spherical body 110 inserted into the accommodation space 108. The spherical body 110 has a through bore (not shown) extending therethrough, with the outlet 32A at a distal or outward end of the bore. In another alternative embodiment, instead of being defined by a jet insert, the outlet 32A can be molded, cut, or otherwise formed in the nozzle housing 104 and modified to allow the nozzle housing 104 to produce the required spray pattern without a separate spray-building element or jet insert.

The jet insert 106 can be fixed within the nozzle housing 104 to direct the jet spray pattern 102 in a predetermined orientation, or can be adjustably mounted in the nozzle housing 104 to adjust the orientation of the jet spray. For example, the jet insert 106 can be rotationally mounted within the nozzle housing 104 via the spherical body 110, and rotating the spherical body 110 within the accommodation space 108 permits the orientation of the jet spray to be adjusted.

The eye ball-type nozzle tip 32 can be snap-fit to the nozzle receiver 100. The nozzle tip 32 and nozzle receiver 100 can have snap-fit parts which are pushed together to interlock the eye-ball type nozzle tip 32 to the nozzle head 12. Providing the snap-fit parts as integral attachment features on the nozzle tip 32 and nozzle head 12 provides rapid assembly, without the need for tools, and avoids loose parts as found with assembly methods using separate screws or fasteners. Where the nozzle tip 32 and nozzle head 12 are plastic, the snap-fit parts can be integrally formed therewith. Other attachment structures are possible. When installed, the nozzle tip 32 can project outwardly from the nozzle cap 16.

The fourth nozzle 32 can have a different flow rate, flow type, pressure, direction, and/or pattern type than the first, second and/or third nozzle 26, 28, 30. For example, the direction of cleaning media sprayed by the outlet and the spray pattern can be different. As shown in FIG. 10, the fourth nozzle 32 produces a focused jet spray 102 generally in a direction outward from the jet insert 106.

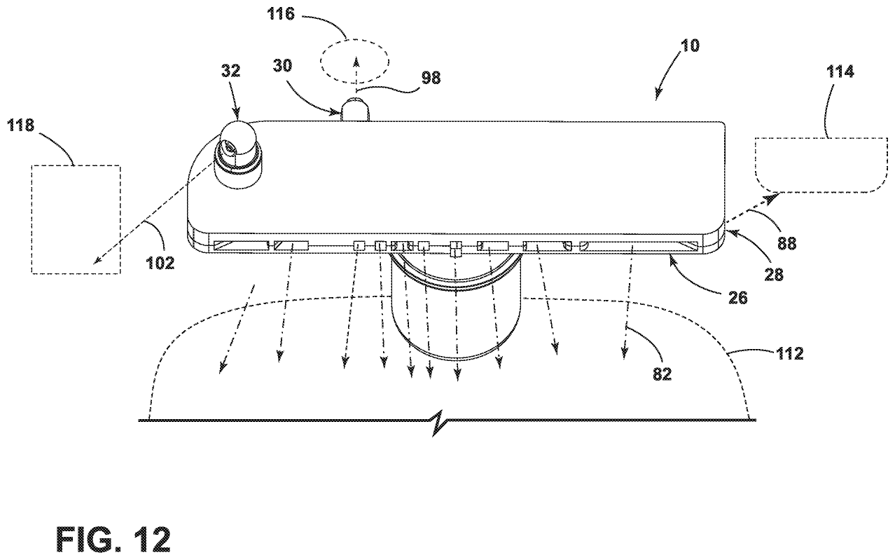

Referring to FIG. 12, the nozzle assembly 10 is shown installed on a vehicle and mounted in proximity to a vehicle window 112, a camera sensor 116, a LIDAR sensor 118, and a CMHSL 114. The nozzle assembly 10 can be a modular assembly for easy installation and servicing. With the unitary assembly, multiple nozzles can be simultaneously installed on the vehicle. Such installation can be completed by making necessary mechanical and fluid connections. Another advantage of the nozzle assembly 10 is that the use of one nozzle head 12 and manifold to mount and supply multiple nozzles can conserve space, reduce weight, and decrease assembly time.

In FIG. 12, the first nozzle 26 comprises a window nozzle comprises at least one outlet orifice that is oriented to direct fluid toward the window 112, the second nozzle 28 comprises a CMHSL nozzle comprising at least one outlet orifice that is oriented to direct fluid toward the CMHSL 114, the third nozzle 30 comprises a camera sensor nozzle comprising at least one outlet orifice that is oriented to direct fluid toward the camera sensor 116, and the fourth nozzle 32 comprises a LIDAR sensor nozzle passageway to supply cleaning media to the LIDAR sensor 118. The manifold internal to the nozzle head 12 supplies cleaning media to each of these nozzles.

Various flow control means can aid in connecting the nozzle assembly 10 and its components with each other to establish a flow path for cleaning media. For example, one or more flow control valves (not shown) can control the flow of cleaning media through the nozzle assembly 10, or through a nozzle of the nozzle assembly 10. In one configuration, a check valve can be incorporated or integrated with the nozzle assembly 10 and is configured for unidirectional flow into or through the nozzle. Aside from this function, the check valve is not particularly limited, and may comprise any components and/or configurations suitable for use in/as a check valve known in the art.

Various connection means can aid in connecting the nozzle assembly 10 and its components with each other to establish a flow path for cleaning media. For example, a quick connector can be provided to connect the cleaning media inlet with a source of cleaning media. In one configuration, the quick connector can comprise a female connector configured to receive a male connector, and a locking member slidable in a transverse direction to lock the connectors together. The quick connector may also take on forms different from what is disclosed in the aforementioned references. Aside from the function of quick connection, the quick connector is not particularly limited, and may comprise any components and/or configurations suitable for use in/as a quick connector known in the art.

As used wherein, the term “cleaning media” encompasses fluid substances that are capable of flowing, including liquid, air, and mixtures thereof. The term “air” encompasses air and any other gas or mixtures of gasses, unless otherwise noted.

The terms “connected” or “connect” are used herein in their broadest sense to mean and encompass the notions of being formed or integrated with, mounted or attached to, coupled, or otherwise joined.

Directional terms, such as “vertical.” “horizontal,” “top.” “bottom,” “upper.” “lower.” “inner.” “inwardly,” “outer” and “outwardly,” are used to assist in describing the invention based on the orientation of the embodiments shown in the illustrations. The use of directional terms should not be interpreted to limit the invention to any specific orientations.

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples.

It is to be understood that the appended claims are not limited to express and particular apparatus or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

The present invention has been described herein in an illustrative manner, and it is to be understood that the terminology that has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

1. A fluid nozzle assembly for cleaning multiple vehicle surfaces comprising:
a nozzle head for mounting in proximity to multiple vehicle surfaces, the nozzle head comprising:
a nozzle body;
a nozzle cap attached to the nozzle body; and
a manifold defined by the nozzle body and the nozzle cap, the manifold comprising an internal cleaning media passage having a plurality of cleaning media passageways;
a cleaning media inlet fluidly coupled to the nozzle head and through which a cleaning media is supplied to the nozzle head from a cleaning media source; and
a plurality of nozzles carried by the nozzle head, each of the plurality of nozzles fed by one of the plurality of cleaning media passageways and having at least one outlet through which cleaning media is sprayed;
wherein one of the plurality of nozzles provides a different flow rate, flow type, pressure, direction, or spray pattern of cleaning media than at least one other nozzle.

2. The fluid nozzle assembly of claim 1, wherein the cleaning media inlet is formed on the nozzle body and comprises a supply conduit extending from a first side, the nozzle cap attached to a second side of the nozzle body opposite the first side.

3. The fluid nozzle assembly of claim 2, wherein an inner surface of the nozzle cap is disposed in opposition to an outlet of the supply conduit, the outlet of the supply conduit supplying cleaning media to the internal cleaning media passage.

4. The fluid nozzle assembly of claim 1, wherein the manifold; comprises a plurality of flow diverters dividing the internal cleaning media passage into the plurality of cleaning media passageways, optionally wherein the plurality of flow diverters are integrally formed with at least one of the nozzle body and the nozzle cap.

5. The fluid nozzle assembly of claim 4, wherein the plurality of flow diverters include a first set of flow diverters integrally formed with the nozzle body and a second set of flow diverters integrally formed the nozzle cap, wherein first set of flow diverters are connected with the second set of flow diverters.

6. The fluid nozzle assembly of claim 4, wherein at least one of the plurality of flow diverters includes a divider surface separating an entrance to a first cleaning media passageway from an entrance to a second cleaning media passageway.

7. The fluid nozzle assembly of claim 4, wherein at least one of the plurality of flow diverters includes deflector wall extending into the passageway and positioned in opposing relationship to a flow direction of cleaning media through the passageway.

8. The fluid nozzle assembly of claim 1, wherein:
the plurality of nozzles comprises a first nozzle integrally formed with the nozzle head and defined by the nozzle body and the nozzle cap; and
the nozzle head comprises a perimeter edge including at least a first peripheral surface, wherein an outlet of the first nozzle is formed by a plurality of openings through the first peripheral surface, the plurality of openings defined by the nozzle body and the nozzle cap.

9. The fluid nozzle assembly of claim 8, wherein the plurality of openings comprise at least one of:
a first opening having a first opening width and a second opening having a second opening width that is greater than the first opening width; and
at least one horizontal nozzle orifice providing a horizontal spray pattern and at least one vertical nozzle orifice providing a vertical spray pattern that is transverse to the horizontal spray pattern.

10. The fluid nozzle assembly of claim 1, wherein at least one of the plurality of nozzles is attached to the nozzle head and is inserted into a nozzle receiver that is one of:
defined between the nozzle body, and the nozzle cap; and
formed on the nozzle cap.

11. The fluid nozzle assembly of claim 1, wherein the nozzle head comprises a plurality of nozzle receivers and wherein the plurality of nozzles comprise at least two of:
an adjustable eye ball-type nozzle tip to produce a conical spray pattern, the adjustable eye ball-type nozzle tip received within one of the plurality of nozzle receivers;
a static fan nozzle tip to produce a static fan spray pattern, the static fan nozzle tip received within one of the plurality of nozzle receivers; and
a chip to produce an oscillating fan spray pattern, the chip received within one of the plurality of nozzle receivers.

12. The fluid nozzle assembly of claim 1, wherein the nozzle head comprises a perimeter edge including at least a first peripheral surface and a second peripheral surface, and the plurality of nozzles comprises at least a first nozzle disposed at the first peripheral surface and a second nozzle disposed at the second peripheral surface.

13. The fluid nozzle assembly of claim 12, wherein an outlet of the first nozzle is formed by an opening; through the first peripheral surface, the opening defined by an aperture in at least one of the nozzle body and the nozzle cap.

14. The fluid nozzle assembly of claim 1, wherein the plurality of cleaning media passageways includes a first cleaning media passageway comprising a channel integrally formed with one of the nozzle body, and the nozzle cap, wherein the channel is closed by the other one of the nozzle body 44 and the nozzle cap.

15. The fluid nozzle assembly of claim 14, wherein the plurality of cleaning media passageways includes a second cleaning media passageway comprising:
a first channel integrally formed with the nozzle body; and
a second channel integrally formed with the nozzle cap, the second channel coupled with the first channel.

16. The fluid nozzle assembly of claim 1, wherein the plurality of cleaning media passageways have at least one of:
unequal fluid volumes, with a first one of the plurality of nozzles supplied by a first cleaning media passageway having a first fluid volume and a second one of the plurality of nozzles supplied by a second cleaning media passageway having a second fluid volume that is greater than the first fluid volume;
unequal flow rates, with a first cleaning media passageway having a first flow rate and a second cleaning media passageway having a second flow rate that is greater than the first flow rate; and
unequal pressures, with a first cleaning media passageway having a first pressure and a second cleaning media passageway having a second pressure that is greater than the first pressure.

17. The fluid nozzle assembly of claim 1, wherein the plurality of cleaning media passageways includes a first cleaning media passageway comprising a laminar flow passageway and a second cleaning media passageway comprising a turbulent flow passageway.

18. The fluid nozzle assembly of claim 1, wherein the plurality of nozzles comprise at least two nozzles selected from:
an in-mold static fan nozzle to produce a static fan spray pattern;
a static fan nozzle tip to produce a static fan spray pattern;
an eye ball-type nozzle tip to produce a conical spray pattern;
an oscillating fan chip to produce an oscillating fan spray pattern; and
an in-mold oscillating fan nozzle to produce an oscillating fan spray pattern.

19. The fluid nozzle assembly of claim 1, wherein at least one of plurality of nozzles comprises a spray building element, the spray building element comprising one of:
a chip inserted between the nozzle body and the nozzle cap; and
an in-mold element integrally formed with at least one of the nozzle body and the nozzle cap.

20. A fluid nozzle assembly for cleaning multiple vehicle surfaces comprising:
a nozzle head for mounting in proximity to a vehicle window, a CMHSL a camera sensor, and a LIDAR sensor, and the nozzle head comprising a first nozzle body and a second nozzle body comprising a nozzle cap attached to the first nozzle body;
a cleaning media inlet, fluidly coupled to the nozzle head and through which a cleaning media is supplied to the nozzle head; from a cleaning media source;
a plurality of nozzles supported by or formed on the nozzle head, including at least:
a window nozzle comprising at least one outlet that is oriented to direct fluid toward the window;
a CMHSL nozzle comprising at least one outlet, that is oriented to direct fluid toward the CMHSL;
a camera sensor nozzle comprising at least one outlet that is oriented to direct fluid toward the camera sensor; and
a LIDAR sensor nozzle comprising at least one outlet that is oriented to direct fluid toward the LIDAR sensor; and
a manifold defined by the first nozzle body and the nozzle cap, the manifold comprising an internal cleaning media passage having a plurality of cleaning media passageways including at least;
a window nozzle passageway to supply cleaning media to the window nozzle;
a CMHSL nozzle passageway to supply cleaning media to the CMHSL nozzle;
a camera sensor nozzle passageway to supply cleaning media to the camera sensor nozzle; and
a LIDAR sensor nozzle passageway to supply cleaning media to the LIDAR sensor nozzle.
